(19) United States
(12) Patent Application Publication
(10) Pub. No.: US 2026/0023545 A1
(43) Pub. Date: Jan. 22, 2026

(54) OPTIMIZING HOOK CODE IN WEBSITE BUILDING SYSTEMS USING FEEDBACK LOOPS

(71) Applicant: Wix.com Ltd., Tel Aviv (IL)

(72) Inventor: Yaniv EVEN-HAIM, Tel Aviv (IL)

(21) Appl. No.: 19/274,984

(22) Filed: Jul. 21, 2025

Related U.S. Application Data
(60) Provisional application No. 63/673,731, filed on Jul. 21, 2024.
(60) Provisional application No. 63/840,925, filed on Jul. 9, 2025.

(51) Int. Cl. G06F 8/41; G06F 8/35; G06F 8/36

(52) U.S. Cl. CPC G06F 8/443; G06F 8/35; G06F 8/36

(57) ABSTRACT

A website building system (WBS) hook code optimization system includes a website session repository, an event receiver, a hook code bundler, an optimization determiner, a code creator, and a hook code executor. The website session repository stores historical performance data from a plurality of hook code executions. The event receiver receives an event associated with hook code, and the hook code bundler creates a hook code bundle based on that event. The optimization determiner analyzes the historical data to generate optimization instructions for the bundle. Following these instructions, the code creator generates execution code for an optimized hook code bundle. The hook code executor runs the optimized bundle, generating current performance results for the event. Finally, the executor logs these results back into the repository, updating the historical data to enable subsequent optimizations in a continuous feedback loop.

### CROSS REFERENCE TO RELATED APPLICATIONS

This application claims priority from U.S. Provisional Patent Application No. 63/673,731, filed Jul. 21, 2024, and U.S. Provisional Patent Application No. 63/840,925 filed Jul. 9, 2025, both of which are incorporated herein by reference.

### FIELD OF THE INVENTION

The present invention relates to website building system generally and to optimization of hook code in particular.

### BACKGROUND OF THE INVENTION

Website building systems (WBSs) provide platforms that allow designers or WBS users to create and manage websites for their end-users without extensive coding knowledge. Typical site creation may be based on a number of models, including a visual editing model (in which the user edits a previously created site) and an automatic site generation model or a combination thereof as is illustrated in FIG. 1 to which reference is now made and is described in U.S. Pat. No. 10,073,923 entitled “System and Method for the Creation and Update of Hierarchical Websites Based on Collected Business Knowledge” granted 11 Sep. 2018, commonly owned by the Applicant and incorporated herein by reference.

FIG. 1 illustrates a WBS 100 in communication with WBS vendor staff 61, a site designer 62 (i.e., a WBS user), a site user 63 (i.e., user of user or end-user) and in communication with external systems 70 (such as third party applications and web services). WBS 100 may further comprise a WBS site manager 10, an object marketplace 15, a WBS RT (runtime) server 20, a WBS editor 30, a site generation system 40 and a WBS content management system (CMS) 50. It will be appreciated that CMS 50 may typically store user and site information. The functionality of these elements is further described in U.S. Pat. No. 10,073,923.

WBSs typically include features for adding custom code, known as hook code, which runs in conjunction with various events triggered by a website of the WBS. Hook code can be associated with (and run synchronously with) different website related events such as clicking on a button, filling a field with data, sending an order, choosing a date, etc. The use of hook code can enhance website functionality, customize user experiences, and integrate with external components or services. Reference is now made to FIG. 2 which illustrates uses for hook code within a WBS such as input validation, data processing, UI customization, third party integration, performance monitoring, security checks and error handling.

Hook code typically executes synchronously with the main website code, enabling immediate interaction with website events. It can be configured to run before, after, or in parallel with the main event. The website may also access components through various methods that are not regular program execution or function calls. Such methods may include (for example) application programming interfaces (APIs), serial peripheral interfaces (SPIs), web service calls, advanced program to program (APPC), or other methods. Component execution could be synchronous or asynchronous. External components can also include data sources and tool providers, such as those provided by Model Context Protocol (MCP) servers.

### SUMMARY OF THE PRESENT INVENTION

There is therefore provided, in accordance with a preferred embodiment of the present invention, a website building system (WBS) hook code optimization system including at least one repository, an event receiver, an optimization determiner, a code creator, and a hook code executor. The at least one repository is configured to store historical performance data, main site parameters (MSPs), and main user parameters (MUPs) of websites built using the WBS. The event receiver is configured to receive an event associated with hook code. The optimization determiner includes a static optimization determiner to perform an offline optimization before runtime by analyzing the historical performance data, the MSPs, and the MUPs, and a dynamic optimization determiner to perform an online optimization during a live website session by analyzing session-specific context data including current user and site parameters, where the optimization determiner uses at least one of: a statistical model and an artificial intelligence (AI) model and where the optimization determiner determines which optimization method to use based on available resources and associated context associated with type of optimization required. The code creator is configured to create optimized hook code based on instructions from the optimization determiner. The hook code executor is configured to execute the optimized hook code.

Moreover, in accordance with a preferred embodiment of the present invention, the code creator uses a large language model (LLM) to generate code for execution of the optimized hook code.

Further, in accordance with a preferred embodiment of the present invention, the LLM is at least one of: internal and external to the WBS.

Still further, in accordance with a preferred embodiment of the present invention, the LLM is fine-tuned on hook source code stored in the at least one repository.

Additionally, in accordance with a preferred embodiment of the present invention, the LLM uses Retrieval-Augmented Generation (RAG) techniques to access code stored inside and outside of the at least one repository.

Moreover, in accordance with a preferred embodiment of the present invention, the code creator further includes a prompt generator for retrieving a prompt template from the at least one repository and generating a prompt for the LLM based on the instructions from the optimization determiner.

Further, in accordance with a preferred embodiment of the present invention, the static optimization determiner performs the offline optimization by analyzing aggregated data from a plurality of past user interactions to make structural improvements to the hook code.

Still further, in accordance with a preferred embodiment of the present invention, the dynamic optimization determiner performs the online optimization by performing intelligent execution reordering of the hook code based on a predicted likelihood of success or failure in the live website session.

There is therefore provided, in accordance with a preferred embodiment of the present invention, a computer-implemented method for optimizing hook code in a website building system (WBS). The method involves storing historical performance data, main site parameters (MSPs), and main user parameters (MUPs), receiving an event associated with hook code, determining an optimization method from a group including at least a statistical model and an artificial intelligence (AI) model, the determination being based on available resources and an associated context, performing an optimization using the determined optimization method, the performing including at least one of an offline optimization before runtime by analyzing the historical performance data, the MSPs, and the MUPs, and an online optimization during a live website session by analyzing session-specific context data including current user and site parameters, generating execution code for the optimized hook code based on instructions resulting from the performing an optimization, and executing the optimized hook code.

Moreover, in accordance with a preferred embodiment of the present invention, the generating execution code is performed using a large language model (LLM).

Further, in accordance with a preferred embodiment of the present invention, the method further includes fine-tuning the LLM on hook source code associated with the historical performance data.

Still further, in accordance with a preferred embodiment of the present invention, the LLM is at least one of internal and external to the WBS.

Additionally, in accordance with a preferred embodiment of the present invention, the LLM is fine-tuned on hook source code stored in at least one repository.

Moreover, in accordance with a preferred embodiment of the present invention, the LLM uses Retrieval-Augmented Generation (RAG) techniques to access code stored inside and outside of at least one repository.

Further, in accordance with a preferred embodiment of the present invention, where generating execution code is performed using an LLM, the method further includes retrieving a prompt template from at least one repository and generating a prompt for the LLM based on the instructions from the optimization.

Still further, in accordance with a preferred embodiment of the present invention, offline optimization is performed by analyzing aggregated data from a plurality of past user interactions to make structural improvements to the hook code.

Additionally, in accordance with a preferred embodiment of the present invention online optimization is performed by performing intelligent execution reordering of the hook code based on a predicted likelihood of success or failure in the live website session.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for the creation and update of hierarchical websites.

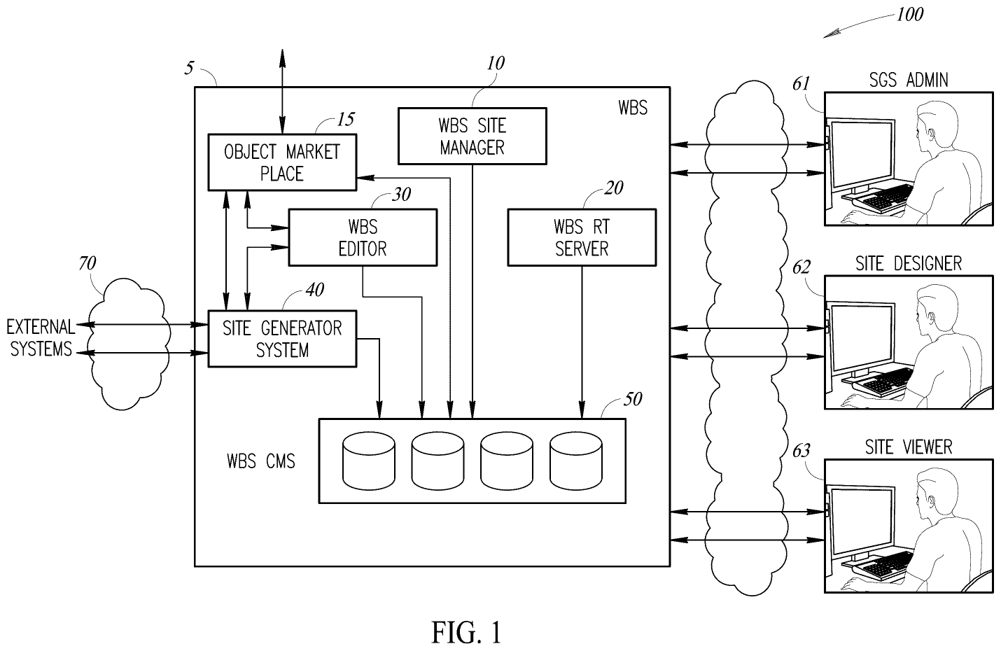

FIG. 2 is a schematic illustration of examples of different uses of hook code used with the system of FIG. 1.

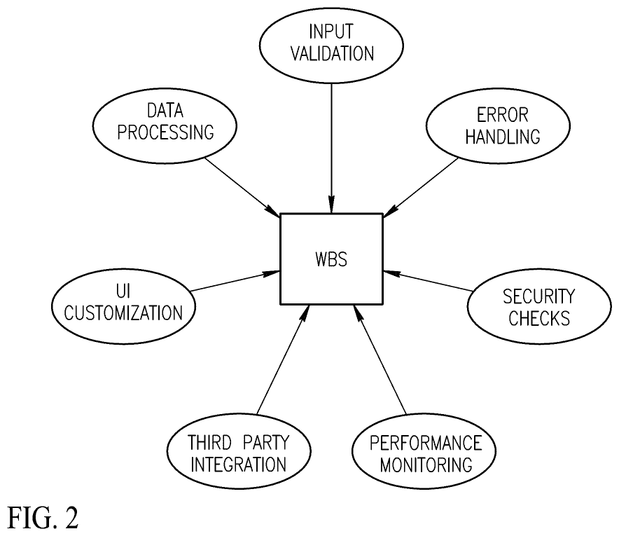

FIG. 3 is a schematic diagram for a website building system hook code optimization system, constructed and operative in accordance with the present invention;

FIG. 4 is a schematic illustration of the elements of FIG. 3, constructed and operative in accordance with the present invention;

FIG. 5 is a schematic illustration to an alternative embodiment for the elements of FIG. 3, constructed and operative in accordance with the present invention;

FIG. 6 is an illustration of an example prompt used by the system of FIG. 3 to query a large language model (LLM), constructed and operative in accordance with the present invention;

FIG. 7 is an illustration of example instructions in JSON sent by the optimizer determiner of FIG. 3 to the code creator, constructed and operative in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that hook code optimization is crucial to website building systems (WBSs) due to its significant impact on overall system performance, resource consumption, and user experience. As described herein above, hook code runs synchronously with various events triggered by the WBS, such as clicking a button, filling a field with data, or sending an order. Without proper optimization, this synchronous execution can lead to substantial slowdowns in website performance, especially when multiple hooks are involved across different events. The blocking nature of synchronous hook code can create scalability and extensibility problems that are unique to website execution environments.

For example, suboptimal hook code could lead to suboptimal resource usage, with synchronous execution causing unnecessary central processing unit (CPU) and memory consumption due to sequential processing where parallelization could be beneficial. This inefficiency escalates hardware requirements and energy consumption for WBS hosting servers. As WBSs scale, the lack of advanced optimization techniques necessitates frequent infrastructure upgrades, increasing costs and complexity. Suboptimal hook code execution introduces latency in website interactions, degrading user experience and potentially increasing bounce rates. It may also result in unnecessary API calls and data transfers, increasing network traffic and affecting other network-dependent applications. Ineffective caching and optimization lead to redundant data storage and repeated computations, increasing storage requirements and data management costs. The inability to parallelize hook code execution creates processing bottlenecks, especially during peak times, often leading to over-provisioning of resources. Finally, inefficient execution increases heat generation in server hardware, necessitating more robust cooling systems and increasing energy consumption and operational costs, reducing the sustainability of the WBS.

The art of code optimization is well-researched and implemented in various domains, including processors, motherboards, operating systems, applications, databases, and many more. In software systems, optimization can be applied in various stages, including compile-time and runtime.

Optimization may apply to source code, executable code, or declarative code. It can also apply to the elements that are not software code per se. For example, query optimizers determine the best way to execute a query, although the query is not software code.

Traditional optimization methods try to improve sequential or otherwise synchronous code execution. An example can be found in processors that use speculative execution or compilers that convert sequential code to parallel one. This optimization is done after analyzing the specific file or using statistics from previous runs of the program.

In regular hook code optimization (including the parallel case), the module performing the optimization has substantial (if not complete) knowledge of the optimized code. For example, it would typically have access to the code area being optimized, whether the entire program or specific sections of the program. The optimizer may function based on global knowledge of the underlying codebase or only manage a small “window” of the executed code (known as “peephole optimization”).

Applicant has realized that existing code optimization techniques are ill-suited for the unique computational model of a WBS. Unlike monolithic applications, a WBS environment is inherently fragmented, comprising code from multiple vendors including the WBS platform itself, third-party application developers, and site designers running across a distributed network of servers and client machines. Components may also be provided by configurable website applications, list applications, app markets or model context protocol (MCP) servers. Consequently, traditional optimizers fail because they cannot operate on the “black box” components of such third-party applications and web services, for which they lack source code access. Moreover, these conventional methods are not designed to reconcile the potentially conflicting optimization interests of multiple clients, such as the WBS platform versus the individual websites it hosts. This challenge is further compounded by the fact that this external code is dynamic and may change at any time, even between sequential executions, and is often accessed indirectly through abstraction layers or mapping mechanisms, such as virtual data tables, rather than through direct function calls.

As discussed herein above, a WBS may also access code external to its system. Interfacing with external systems 70 to the WBS such as third-party applications or web services, may typically be achieved through various methods. For instance, interfacing can be performed by directly embedding the relevant calls within the executable part of a website's definition. Alternatively, interfacing may be accomplished by mapping external components or services to virtual database records. In such a scenario, the website would access an auxiliary data source, where virtual record accesses are programmatically mapped to the corresponding web service calls. This mapping mechanism may allow a website designer to define attributes of the virtual table, such as which fields are query-able or sortable, potentially requiring query optimization when combining or accessing these virtual tables. This may also be achieved with complex mechanisms that abstract external APIs or services such as virtual tables, requiring query optimization, field restriction, and dynamic adaptation. Relevant external service information may also be stored in CMS 50.

WBS users or designers can also add code that runs before or after the main code (created automatically or manually) runs. Such synchronous hook code may block the execution of the website and create problems of scalability and extensibility for website execution.

Applicant has further realized that hook code optimization within a WBS environment may harness knowledge or data of the WBS users or designers, the websites it stores, their attributes and environmental data such as devices used, geolocation information, network parameters, and quality, including during both website creation and editing (“development time”) and website access (“run time”). This may include WBS users (such as site designers) as well as site viewers (end-users).

Such data may include site content, layout, and visual elements. It may include designer attributes (e.g., editing history, experience level, sites created, geography, age, industry segment, etc.). It may also include site information extracted from websites such as business intelligence (BI), end-user activity, geography, vertical applications, installed modules and third party applications, resource consumption, performance, etc. The BI and end-user activity data, in particular, may include the mapping of end-users and their paths through websites created or hosted by the WBS. Thus, the WBS may have a comprehensive picture of how users interact with websites, as well as the related inputs and outputs.

For referenced external code (extensions, web services, third party applications, MCPs etc.), the WBS may gather information about their inputs, outputs, execution time, latency, resource consumption, consistency, failure rates, etc.). It will be appreciated that external code may provide versioning information (e.g., “the called service was upgraded from v1.1 to v1.2), which may be used by an optimization system to invalidate pre-calculation or other forms of result caching or analysis of expected results.

Applicants have realized that the above mentioned limitations can be overcome with an optimization system integrated within a WBS that can significantly enhance the performance, scalability, and efficiency of hook code execution. The system may utilize knowledge from stored WBS main site parameters (MSPs) about websites built using the WBS and main user parameters (MUPs) about designers subscribed to the WBS that build the websites as well as end-user data about users of the published websites. It may also harness knowledge from data from external systems together with general execution data of a multitude of website user sessions (such as execution time, latency, resource use and contextual data). The system may use feedback loops utilizing this data to make intelligent, context-aware optimizations, both before runtime (statically) and during runtime (dynamically). The optimization system may recommend pre-hook, post-hook, and parallel logic and may notify the WBS user (e.g., site designer) of missing or inadequate logic. It may then rewrite or reorganize any relevant code to make websites perform more efficiently without requiring full access to the source code being optimized.

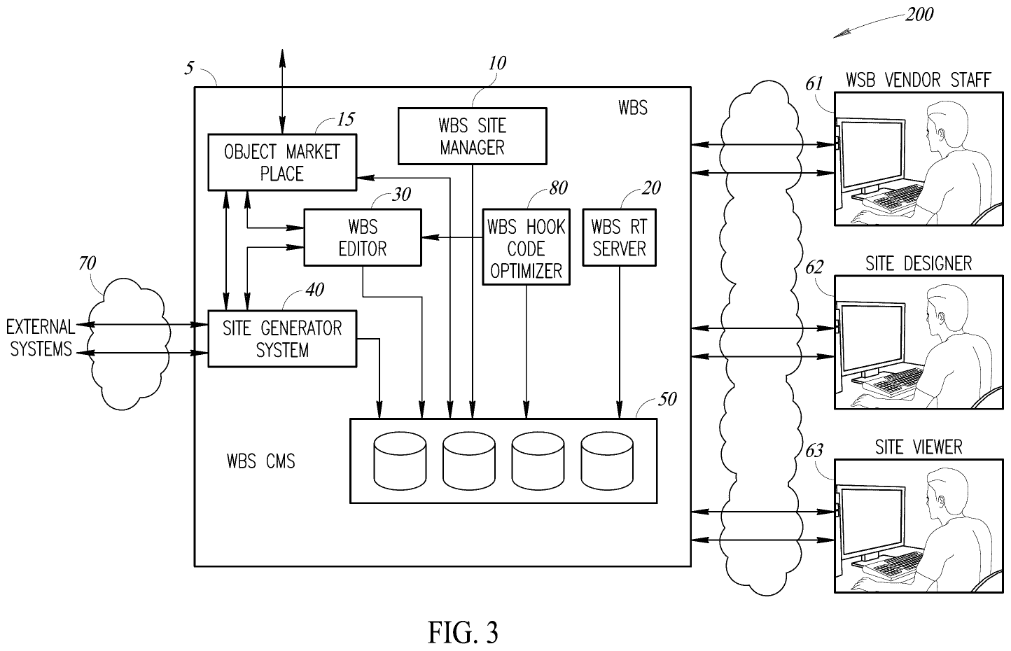

Reference is now made to FIG. 3 which illustrates a WBS hook code optimization system 200 in accordance with an embodiment of the present invention. System 200 may comprise the elements of system 100 as described in U.S. Pat. No. 10,073,923 (as well as any sub elements) in conjunction with a WBS hook code optimizer 80.

It will be appreciated that in an alternative embodiment, WBS hook code optimizer 80 may be external to WBS 100 and be standalone.

As discussed in U.S. Pat. No. 10,073,923, content management system (CMS) 50 may store a wide range of information related to website building, including templates for website building, user data, design elements, system components and content. It may be a single repository or made be made up of multiple repositories. Data stored may also include but not be limited to editing history, business intelligence and rules for website building. It may further store other parameters such as snippets of hook code, information relation to external systems in communication with the WBS such as API's, virtual tables etc. It may further store templates for prompts to an external large language model (LLM) such as ChatGPT (commercially available from Open.AI) or to other technologies, generative or otherwise.

It will be appreciated that optimization may be static, i.e., happen before reaching runtime. This optimization is done on the code and uses statistical data from multiple WBS runs. Static optimization usually happens on the back end, enabling the WBS server to serve the client with code bundles that are optimized for the conditions of the client device or user. This kind of optimization usually happens on the back end, as it demands substantial resources and has no graphical user interface (GUI).

Dynamic optimization may be achieved at runtime when input for any code snippets is available. By knowing in advance what the standard inputs are, code can be created to optimize execution.

In parallel, the WBS may continue to run extensions as initially planned. If the outcome differs from the expected one, the WBS refreshes the user's screen with the new outcome. This assumes no side effects (or at least side effects that can be managed and, if needed, applied in a delayed or out-of-order manner).

This procedure may rely, in part, on the fact that the WBS web page display process is not serial, but parallel, rendering and displaying multiple page elements simultaneously. Thus, even if some elements need to be redrawn, the combined effect would still be acceptable to site viewers or end-users. This is especially correct if the elements to be redrawn are “below the fold,” i.e., in the part of the webpage that is not initially visible (but only with scrolling).

It will be appreciated that in regular optimization scenarios, the optimization process may have a single “client” or beneficiary, the person running the program or system to be optimized. There may also be multiple clients for the optimization services in the WBS scenario, notably the WBS itself, multiple websites hosted by the WBS (and their owners/operators) and the various end-users viewing these sites. The interests of these different clients may vary and potentially conflict with one another. For example, the WBS may be able to accelerate the performance of a specific website in a way (e.g., through large-scale parallelization), which increases system load for other users or the WBS in general.

As another example, WBS 100 may provide services to any hosted website based on extensions and external services whose prices are subsidized by the WBS vendor and/or charged to the user. In such cases, optimization may reduce the number of calls to these services (e.g., through forecasting or estimating return values), providing a benefit to the WBS owner but not the site owner (user) or vice versa.

As discussed herein above, system 200 may employ feedback loops as part of its optimization system. A feedback loop can be considered a functionality in which some portion (or all) of the system's output is used as input for future operations. Feedback loops in general may have different stages, the capture of created input, analysis of the input, and capturing any insights from the analysis to make future decisions.

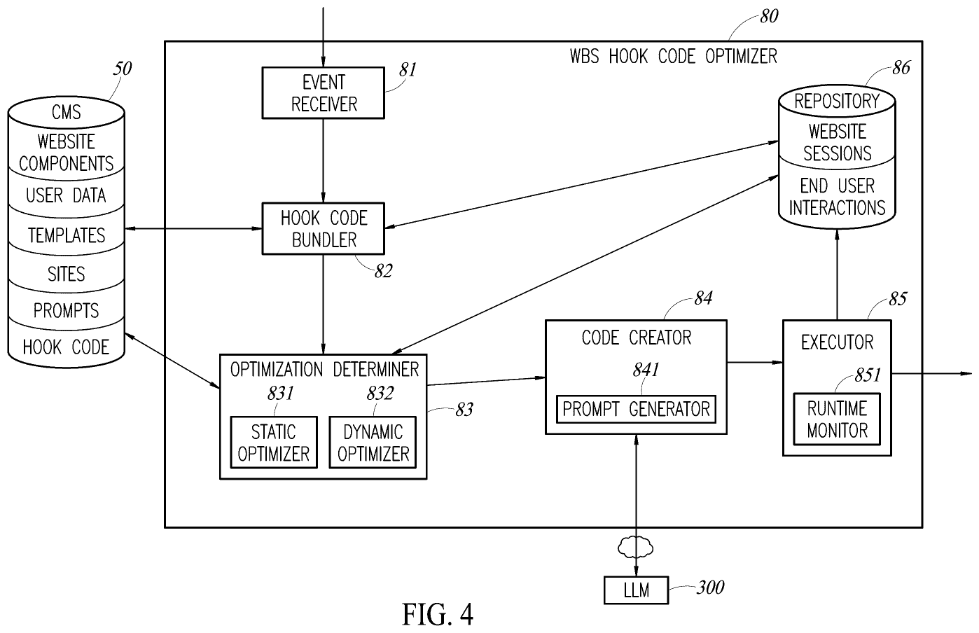

Reference is now made to FIG. 4 which illustrates the sub elements of WBS hook code optimizer 80. WBS hook code optimizer 80 may comprise an event receiver 81, a hook code bundler 82, an optimization determiner 83, a code creator 84, a hook code executer 85 and a website session repository 86 to store the output of executor 85 for use by hook code bundler 82 and optimization determiner 83 as described in more detail herein below. Optimization determiner 83 may further comprise a static optimizer 831 and a dynamic optimizer 832. Executor 85 may comprise runtime monitor 851. Code creator 84 may be in communication with a large language model (LLM) 300 and may further comprise prompt generator 841.

Website session repository 86 may store a comprehensive log of historical performance data and contextual information, serving as a source of input for hook code bundler 82 and optimization determiner 83. The data stored may include but is not limited to execution performance metrics and quantitative measurements of the hook code's operational performance, including latency, outcome status, error details, resource consumption, input and output (I/O) data, user and session context and interactions as well as user environment data (end-user's device type e.g., mobile, desktop, operating system, and browser version).

It may also store network conditions, geographic and temporal data, execution flow and relationship data: (information detailing how hooks interact with one another within a session), data indicating which hooks are executed together in response to a single event or within a short time frame and sequential patterns, the specific order in which hooks were executed.

Event receiver 81 may receive the incoming event (such as a click on a purchase button). As discussed herein above, events may come internally from the WBS or externally from external systems 70 (such as third party applications webs services as described herein above). Hook code bundler 82 may, for static optimization tasks, take hook code associated with the event and “bundle” it into more efficient packages, this may involve grouping related hooks that are always called together. Optimization determiner 83 may analyze performance data to make strategic decisions on how to optimize code and instruct code creator 84 to replace current code with optimized code accordingly which is then run by executor 85. The performance results of the execution are logged back into repository 86 providing fresh data for the next optimization cycle.

Event receiver 81 may receive the incoming event. The event may be retrieved from local or remote servers, manually entered code, and automatically generated code. Alternatively, the code may be executed on a separate, third-party, or external server interfaced with the WBS. It will be appreciated that there may be different types of hook code triggered from an event which could be a user action or system generated event such as a button click, a mouse hover or a page initiation. Hook code may comprise pre-event hooks, post-event hooks, and in-parallel hooks. Pre-event hooks run before the main event are processed, typically handling tasks like input validation or preparation. Post-event hooks execute after the main event has been processed, often used for cleanup, notification, or further processing of event results. In-parallel hooks may run concurrently with the main event processing, allowing for operations that can be performed independently and potentially improving overall performance through parallel processing. Additionally, other types of hooks may comprise pure function hooks, which always produce the same output for a given input and can be easily memorized or cached, and non-pure function hooks, which may have varying outputs and require more complex optimization strategies.

Hook code bundler 82 may perform initial bundling or grouping of the incoming hook code with other hooks that are frequently used together, predicted to be used together, or designated to be used together during the website building process. It will be appreciated that hook code may be retrieved from CMS 50, which stores hook code which is associated with events i.e., explicitly defined during the website creation process. Patterns and sequences of use of hook code may also be determined from the execution data stored in repository 86. It will be appreciated that the primary purpose of bundles is to enhance performance by grouping related hooks or hook code and optimizing them as a unit, rather than treating each hook in isolation.

For example, event receiver 81 may receive a snippet of hook code such as a “purchase” button click. Hook code bundler 82 may receive the event and retrieve and bundle any associated hook code. For example, the event PurchaseButtonClick (purchase) may have three associated hooks, validatePayment( ), checkInventory( ) and sendConfirmationEmail( ). It will be appreciated that the hooks/hook code may be stored in CMS 50 as part of the stored website information.

It will be appreciated that by bundling or grouping disparate, snippets of code into a single, cohesive unit, hook code bundler 82 may create a holistic view for optimization determiner 83. This bundle is not merely a collection of code; it is enriched with metadata that defines the relationships, dependencies, and intended execution order between the constituent hooks. This contextual understanding may enable activity such as code soldering, where the logic from multiple hooks can be merged into a single, monolithic block. This may allow hook code bundler 82 to identify and eliminate redundancies that exist between hooks, such as repeated validation checks, which would be impossible to detect if each hook were treated as a separate, atomic entity. Furthermore, the defined structure of a bundle may allow hook code bundler 82 to intelligently manage and reorder the execution flow based on aggregated performance data. For instance, a high-failure-rate hook can be moved to the front of the execution sequence, allowing the executor 85 to preemptively terminate the entire workflow and conserve resources if it fails, a strategy not feasible without the bundled context. This approach also significantly reduces runtime and management overhead, as the executor 85 (after optimization) handles a single, streamlined bundle rather than managing the lifecycle of numerous individual hooks.

It will be appreciated that hook code bundler 82 may typically employ statistical methodologies known in the art applied to hook code stored in CMS 50 and execution data from website sessions stored in repository 86. Such methodologies may include but not be limited to statistical performance profiling to provide a statistical analysis of performance metrics for individual hooks and bundles. Hook code bundler 82 may calculate key indicators such as mean execution time (latency), standard deviation, resource consumption (CPU/memory), and failure rates. This profiling may determine “hotspots”, code snippets that are computationally expensive or error-prone and flag them as primary candidates for optimization. For example, a hook with a consistently high may would be prioritized for analysis and potential rewriting.

Hook code bundler 82 may employ data mining techniques to discover recurring patterns in hook execution or may employ frequent itemset mining to identify hooks that are always executed together and therefore should be “bundled” and optimized together.

Hook code bundler may further use sequential pattern mining to identify common sequences of execution in order to identify workflows that can be streamlined or soldered as described herein above.

Once the incoming hook code has been bundled, optimization determiner 83 may optimize the bundles, enabling more efficient execution when needed (static optimization) or may optimize them during runtime (dynamic optimization). As discussed herein above, the optimization process may significantly improve the performance and efficiency of hook code execution before it reaches the client-side of the WBS, contributing to faster website operations and better resource management.

It will be appreciated that there may be multiple types of hook code optimization that are relevant to the heterogenous WBS environment and that may be determined and implemented by system 200 such as performance optimization, resource optimization, parallelization, execution re-ordering and de-parallelization, local caching and predictive execution and multiple client optimization.

Performance optimization may be regular optimization of code segments embedded in the defined websites and optimization in the execution of external code (herein “extension”) activated or contacted by the website.

Resource optimization may consider the specific structure of the WBS, and the way resources are defined, allocated, and used within it. In particular, the WBS may have multiple resource categories, including resources that are limited or measured based on a designer classification (such as the designer's subscription level). This may include disk space, throughput, website size in terms of pages, elements, access to third party applications, access to extension modules such as payments, and token limitations for any associated AI modules.

There may be multiple types of parallelization, as the WBS implementation may consist of multiple parallel execution levels (e.g., threads, dockers, virtual machines, servers, etc.). This could include parallelizing regular code and parallelizing calls to web services (and other external components). Parallelization of external components could involve analyzing calls to them, allowing speculative execution of internal and external code elements.

In some cases, the WBS may execute operations in a different order from that defined by the designer or perform some operations sequentially when they have been designated for execution in parallel. This is different from the out-of-order execution implemented in various processors as the analysis may consider not just resource and input data availability but the expected results (and their significance and relevance to the specific user).

For example, an input validation routine V may activate multiple validation services X1, X2, and X3. Routine V may perform them in sequence, in parallel, or a combination of the two.

However, optimization determiner 83 may determine that X2 (for example) is the one most likely to fail based on the specific input being validated. This knowledge may be based on numerous instances of X2 being run in various user sessions, as well as possible an initial analysis of the input value to be validated.

Optimization determiner 83 may thus determine that X2 should be called initially and calls to X1 and X3 (assuming the input to X2 is known or could be derived) should be deferred to save on resources. If X2 fails (as expected), the calls to X1 and X3 may become redundant.

It will be appreciated that memoization is an optimization technique known in the art based on storing the results of calling expensive pure functions and re-using the results when the same inputs occur again. Pure functions (such as mathematical functions, where the output is always the same for a specific input) are easy to optimize, as they will not change regardless of what happens. Non-pure functions can also be optimized, but this is done (for example) using a statistical method (as their output may differ from session to session) and may require replicating known side effects.

Furthermore, optimization determiner 83 may also perform caching of the results of executing complex or external code and use the cached value instead of calling the complex or external code (subject to the resolving of any side effects to that the non-called code may have). Optimization determiner 83 may also implement cache invalidation or flushing procedures (e.g., based on changes in the version of the external code, or on “freshness” of the cached value).

This could include caching multiple values and selecting the appropriate one to use rather than calling the relevant code. Such selection could be based (for example) on user or site parameters and/or the inputs provided to the called code. This may allow optimization determiner 83 to employ a 2-phase optimization based on the following technique (similar to the use of progressive rendering). Using the understanding above, optimization determiner 83 may use a matching cached (or otherwise expected) value as the value the extension returns for a display to the designer followed by a signal (visual or otherwise) to inform the designer that this is an expected/or forecasted value.

As discussed herein above, optimization determiner 83 may comprise a static optimizer 831 and a dynamic optimizer 832.

Static optimizer 831 may perform persistent, offline optimizations on the back-end of WBS 100 before runtime. It may analyze aggregated historical data from repository 86 by leveraging statistical trends and patterns from a multitude of past user interactions to make structural improvements to the hook code. This may also include analyzing advantages and disadvantages of previous optimizations made. Its primary function may be to create highly efficient, pre-optimized assets before they are ever requested by a live website session. The optimizations performed by static optimizer 831 may include behavior modeling based on site designer traits. Static optimizer 831 may analyze how site designers built their sites (e.g., parameters such as speed, structural complexity, past-editing patterns etc. to recommend or skip hook logic. Static optimizer 831 may focus on the big picture and what is most likely to happen. It will be appreciated that one of the advantages of static optimization may be the reduction of bundle size directly impacting performance and memory. For example, if the code handles different UI device types and resolutions differently, it may optimize for the device currently in use.

Dynamic optimizer 832 may make intelligent, real-time execution decisions during a live website session. A live website session could include a designer session, an end-user session or both in parallel. Unlike static optimizer 831, it may operate “online” at the moment an event is triggered, and may use immediate, session-specific context to make its decisions. This context may include the current end user's device type, geographic location, network conditions, and the specific inputs they have provided. For example, end-users from Japan could have a different environment and behavior than end-users from the UK. Thus, the inputs to the hooks (and other context and environmental parameters) will also be different.

Dynamic optimizer 832 may also select the most appropriate execution strategy for any pre-optimized code provided by static optimizer 831. The optimizations performed by dynamic optimizer 832 may include, but are not limited to, intelligent execution reordering, where it alters the sequence of hook execution based on the predicted likelihood of success or failure in the current context; predictive caching, where it may return a cached result instantly if the outcome of a hook can be confidently predicted for the current user; and optimized bundle selection, where it chooses the most suitable pre-optimized code bundle to run from a list of available options based on the user's immediate environment. It will be appreciated the dynamic optimizer 832 may employ “live learning” as part of its functionality, i.e., adjusting model parameters during user sessions. This could include, for example, detecting user site use parameters (and acting based on them). This could also involve detecting user parameters (such as a slow connection) and adjusting the parameters of the hook or external services accordingly (e.g., requesting images to be generated at a lower resolution).

It will be appreciated that similar to hook code bundler 82, static optimizer 831 and dynamic optimizer 832 may utilize statistical analysis (sequences, patterns, and trends) of execution data from repository 86 and analysis of MSPs and MUPs stored in CMS 50. Like hook code bundler 82, they may also employ statistical performance profiling, pattern recognition, data mining, frequent itemset mining and sequential pattern mining together with techniques such as contextual segmentation and analysis i.e., segment historical data based on context. Common segments may include device type, geographic location, and user or site profile. This segmentation may allow optimizers 831 and 832 to generate tailored optimized assets. For example, they might discover that a particular if/else branch in a hook is never executed for mobile users. Based on this analysis, they may (as an example) recommend a mobile-specific version of the code where that branch is completely removed (dead code elimination), resulting in a smaller, faster code bundle for those users.

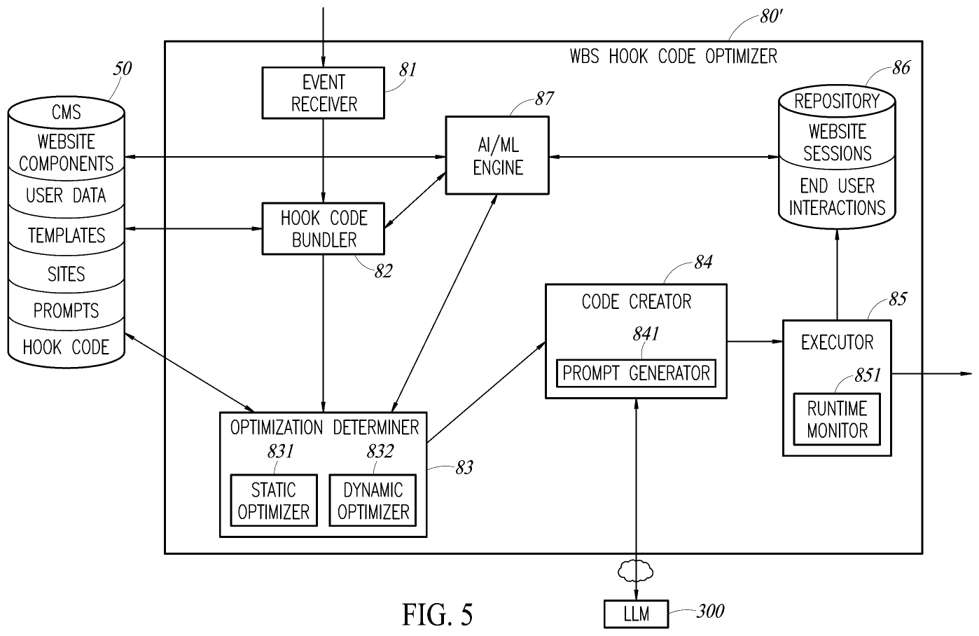

Reference is now made to FIG. 5 which shows an alternative embodiment of hook code optimizer 80′ that employs predictive modelling via an artificial intelligence (AI)/Machine learning (ML) engine 87. It will be appreciated that the functionality of the other elements may function as described herein above. It will be appreciated that AI engine/may comprise machine learning (ML) models to perform the equivalent determinations in tandem or separately to the statistical methodologies as described herein above. These models may be trained using the same data, i.e., the inputs and outputs of known hooks for different WBS users, as well as execution/environmental parameters and context. In this scenario the pertinent element may decide on the choice method (e.g., AI vs. statistical models) based on available resources and context. For example, static optimization may be offline and slower than dynamic optimization which may be online and faster.

AI/ML engine 87 may also use generative AI based algorithms for proposing assets/resources to designers according to information on other designers internal and external to 100 WBS (and subject to all relevant laws, regulations, and IP and other property rights). AI/ML engine 87 may further train machine learning models to provide support for the functionality of the other elements of hook code optimizer 80.

It will be appreciated that the terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fitted or trained on a training dataset (e.g., a set of examples used to fit the parameters of the model). The model may be trained on the training dataset using supervised or unsupervised learning. The model is run with the training dataset and produces a result, which is then compared with a target, for each input vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network). In some embodiments, the model can be trained and/or trained in real-time (e.g., online training) while in use.

The machine learning models, one or more models, trained machine learning models, legitimacy prediction models, improper dispute prediction models, resource volume prediction models, and disputed network transaction prediction models as described above may make use of multiple ML engines, e.g., for analysis, recommendation generating, transformation, and other needs.

AI/ML engine 87 may train different ML models for different needs and different ML based engines. AI/ML engine 87 may generate new models (based on gathered training data) and may evaluate their performance against the existing models. Training data may include any of the gathered information, as well as information on actions performed based on the various recommendations.

The ML models may be any suitable model for the task or activity implemented by each ML-based engine. Machine learning models are known in the art and are typically some forms of neural network. The term refers to the ability of systems to recognize patterns based on existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders, transformer-based), models combining planning with other models (e.g., PDDL-based), or Generative models (e.g., GANs, diffusion-based models).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks, diffusion-based or auto-encoders) to generate definitions and elements.

In various embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

In various embodiments and when appropriate for the particular task, one or more of the ML models may be implemented with rule-based systems, such as an expert system or a hybrid intelligent system that incorporates multiple AI techniques.

A rule-based system is used to store and manipulate knowledge to interpret information in a useful way. It is often used in artificial intelligence applications and research. Rule-based systems constructed using automatic rule inference, such as rule-based machine learning, may be included in this system type. An example rule-based system is a domain-specific expert system that uses rules to make deductions or choices. For example, an expert system might help a doctor choose the correct diagnosis based on a cluster of symptoms or select tactical moves to play a game. Rule-based systems can be used to perform lexical analysis to compile or interpret computer programs, or in natural language processing. Rule-based programming attempts to derive execution instructions from a starting set of data and rules.

A hybrid intelligent system employs, in parallel, a combination of methods and techniques from artificial intelligence subfields, such as neuro-symbolic systems, neuro-fuzzy systems, hybrid connectionist-symbolic models; fuzzy expert systems; connectionist expert systems, evolutionary neural networks, genetic fuzzy systems, rough fuzzy hybridization, and/or reinforcement learning with fuzzy, neural, or evolutionary methods as well as symbolic reasoning methods.

An example hybrid is a hierarchical control system in which the lowest, reactive layers are sub-symbolic. The higher layers, having relaxed time constraints, are capable of reasoning from an abstract world model and performing planning. Intelligent systems usually rely on hybrid reasoning processes, which include induction, deduction, abduction, and reasoning by analogy.

Code creator 84 may translate the strategic instructions received from optimization determiner 83 into tangible, executable code assets. It acts as a generative engine that may take abstract optimization directives such as an instruction to merge a sequence of hooks or to create a context-specific version of a script and produces new, structurally improved code. It does not make optimization decisions itself; rather, it systematically executes the decisions made by optimization determiner 83. The resulting optimized code, which is a new asset distinct from the original input, is then provided to executor 85 for runtime execution.

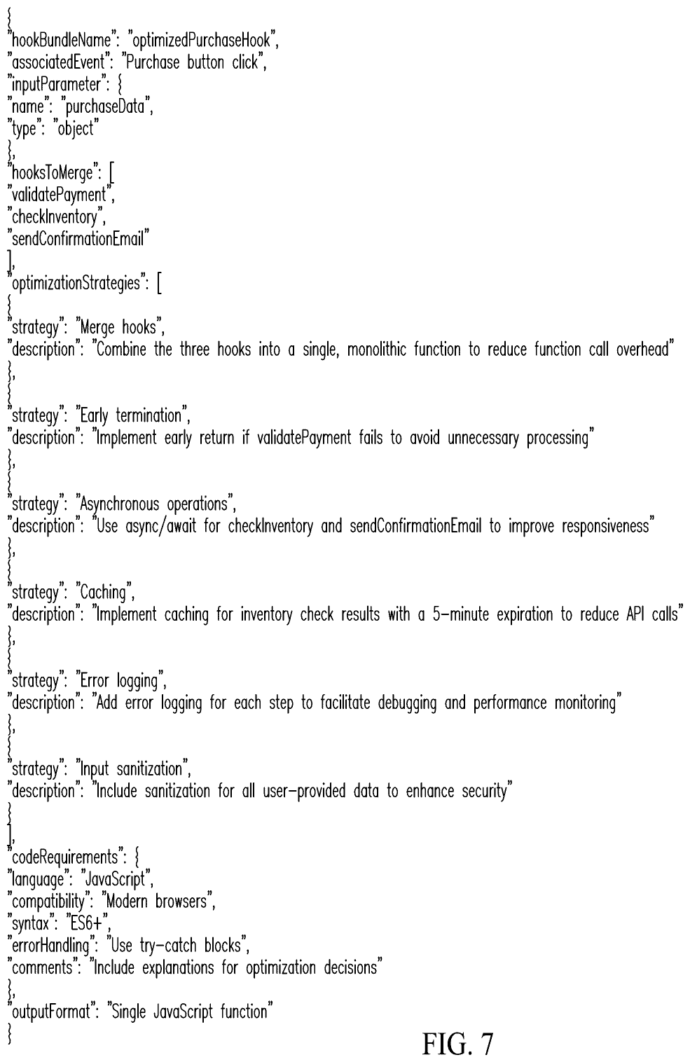

Code creator 84 may create or rewrite code based on the instructions it receives. It may receive a coded instruction set that provides clear guidance on how to generate the optimized code, incorporating the specific optimizations determined by the pertinent optimizer and ensuring the resulting code meets the required standards and functionality. Reference is now made to FIG. 7 which illustrates example JSON instructions sent from optimization determiner 83 to code creator 84 for the purchase button example above. Code creator 84 may also be responsible for generating multiple, context-specific variants of a code asset, such as separate mobile and desktop versions. In more advanced embodiments, it may also perform code refactoring by rewriting inefficient algorithms.

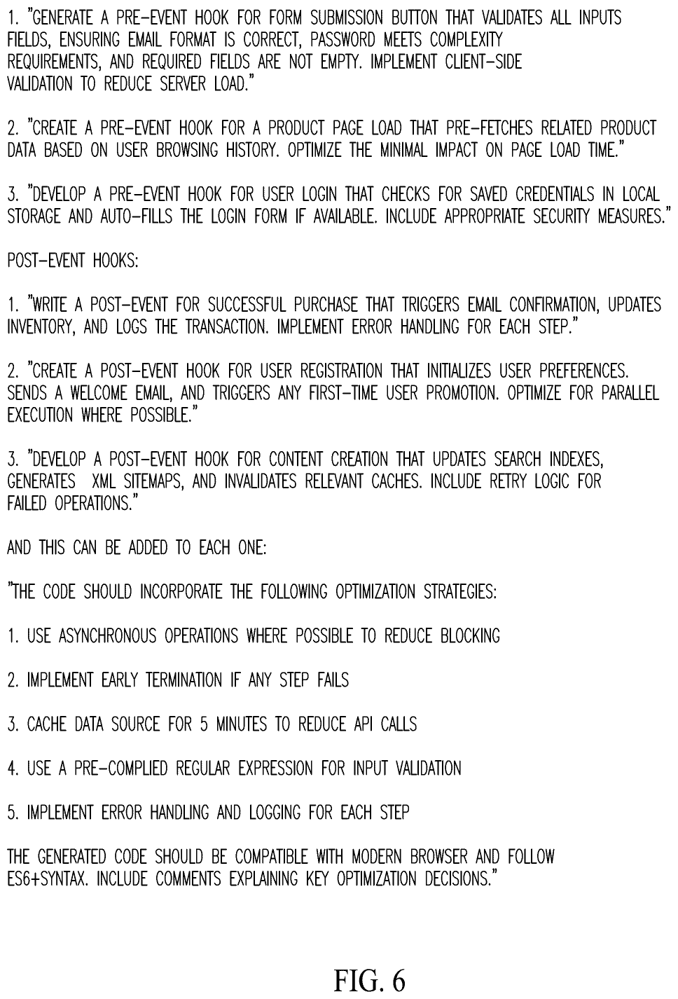

It will be appreciated that code creator 84 may use a known generic LLM 300 to write optimized code according to the output of optimizers 831 and 832. Code creator 84 may also a use an LLM 300 which is purposed, trained, or otherwise optimized for the creation, editing and handling of software code. Code creator 84 may comprise a prompt generator 841 to retrieve an appropriate prompt template from CMS 50 and fill it in accordingly according to the instructions received from the relevant optimizer. Reference is now made to FIG. 6 which illustrates a sample prompt to be used. In some embodiments, LLM 300 may also be fine-tuned on hook source code available in the WBS's CMS 50 so to better handle the user's hook code. Fine tuning is known in the art as taking an existing base LLM (open source or licensed) and training it using source code from CMS 50, repository 86 or from external systems possibly adding metadata (e.g., details of the source code used for training, its origin, its description, etc.). In other embodiments (and in static optimization context in particular), LLM 300 may use RAG-like techniques to extend its “knowledge” to multiple universes of code (inside and outside of the CMS 50 code base). In an alternative embodiment to the present invention when using such fine-tuned code or RAG techniques, LLM 30 may be internal to system 200 and part of the functionality of hook code optimizer 80.

After the hook code has been created/updated by code creator 84, executor 85 may run the code. It will be appreciated that the optimized hook bundles are executed according to their type (pre, in-parallel, or post) and their optimization strategy. Executor 85 may receive the final, high-performance code assets either as consolidated bundles or as newly generated scripts from code creator 84 and ensure they are run at the appropriate moment when an event is triggered. Executor 85 may replace the execution of the original, unoptimized hook code with an improved version, thereby delivering the direct performance benefits, such as reduced latency and increased responsiveness, to the end-user.

Executor 85 may also perform execution reordering for resource-constrained efficiency and support intelligent reordering of hook execution. For example, it may prioritize the call most likely to fail first, based on historical outcome statistics, and skipping the rest if a known outcome is triggered. Executor 85 may also handle the replication or replacement of side effects of some hook code. An example isa case in which the hook code call was replaced using a memorized value, but some specific side effect of the (not-called) hook code still requires replication.

Executor 85 may further comprise a runtime monitor 851. Runtime monitor 851 may be a data collection agent that closes system 200's adaptive feedback loop. Immediately following an execution, runtime monitor 851 may monitor and capture a set of performance metrics and contextual data about the operation. This may include, but not limited to, the execution time (latency), the outcome (success or failure), the specific inputs provided to the hook code, the outputs it generated, and where possible, the resources it consumed. This captured information is then systematically logged and saved to repository 86, providing the raw, real-world data for use by hook code bundler 82 and Optimization determiner 83 for subsequent rounds of analysis and improvement.

Thus system 200 may function a continuous and adaptive loop. It may leverage rich data unique to the WBS environment such as user profiles, site design history, aggregated end-user behavior and website performance to determine the optimization of external code to improve the performance of “black box” code snippets without requiring access to their underlying source code. To achieve this, it may analyze historical performance data to generate highly efficient code bundles, while runtime (dynamic) optimization makes intelligent, context-sensitive decisions during a live user session. The output of this process includes a variety of specific optimization techniques tailored for the WBS environment, such as code soldering to create monolithic code blocks, intelligent re-ordering of execution sequences, predictive caching of results, and the creation of managed hook bundles to streamline performance.

This system 200 may reduce hook code running time through a combination of advanced techniques, including hook code bundling and code soldering, static optimization, dynamic optimization, parallelization of compatible hooks, reordering of execution sequences, and local caching of results (e.g., through memoization). These optimizations may lead to improved user experience, better overall performance, and reduced resource consumption. Furthermore, its feedback loop mechanism allows it to continuously learn and adapt its strategies based on real-world usage data, ensuring that the optimization remains effective over time and across different scenarios. These combined advantages provide significant benefits to both the website building system provider and the websites hosted on the platform.

Unless specifically stated otherwise, as apparent from the preceding discussions, it is appreciated that, throughout the specification, discussions utilizing terms such as “analyzing,” “generating,” “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The elements providing the functionality for the invention may be implemented on a suitable apparatus. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A website building system (WBS) hook code optimization system, said system comprising:
a website session repository to store historical performance data associated with a plurality of hook code executions;
an event receiver to receive an event associated with at least one hook code;
a hook code bundler to create a hook code bundle based on said event;
an optimization determiner to analyze at least said historical performance data from said website session repository to generate one or more optimization instructions for said hook code bundle;
a code creator to generate execution code for a optimized hook code bundle based on said one or more optimization instructions; and
a hook code executor to:
execute said optimized hook code bundle, thereby generating current performance results of hook code for said event; and
log said current performance results into said website session repository to update said historical performance data for subsequent optimizations.

2. The system according to claim 1, wherein said optimization determiner comprises:
a static optimizer to perform an offline optimization by analyzing said historical performance data before runtime; and
a dynamic optimizer to perform online optimization during a live session by analyzing session-specific context data.

3. The system according to claim 1, wherein said code creator is in communication with a large language model (LLM) for generating code for said optimized hook code bundle.

4. The system according to claim 3, wherein said code creator further comprises a prompt generator for generating a prompt for said LLM based on said one or more optimization instructions.

5. The system according to claim 1, wherein said hook code bundler creates said hook code bundle by merging logic from a plurality of hook codes into a single monolithic block.

6. The system according to claim 1, wherein said hook code bundler further reorders an execution flow of a plurality of hook codes within said hook code bundle based on said historical performance data and stored WBS website data and stored WBS user data.

7. The system according to claim 1, wherein said hook code executor further comprises a runtime monitor for logging said current performance results into said website session repository.

8. A system according to claim 1, wherein said historical performance data stored in said website session repository comprises at least one of execution performance metrics, user environment data, and execution flow data.

9. The system according to claim 2, wherein said hook code bundler and said optimization determiner analyze said historical performance data using at least one of: statistical performance profiling, data mining, frequent itemset mining, and sequential pattern mining.

10. The system according to claim 1, further comprising an artificial intelligence (AI)/machine learning (ML) engine, wherein said hook code bundler optimization determiner selects an optimization method from a group comprising at least a statistical model and a machine learning (ML) model implemented by said AI/ML engine, said selection according to available resources and execution context.

11. A computer-implemented method for optimizing hook code in a website building system (WBS), the method comprising:
storing in a website session repository, historical performance data associated with a plurality of hook code executions;
receiving an event associated with at least one hook code;
creating a hook code bundle based on said event;
analyzing at least said historical performance data to generate one or more optimization instructions for said hook code bundle;
generating execution code for a optimized hook code bundle based on said one or more optimization instructions;
executing said optimized hook code bundle, thereby generating current performance results for said event; and
logging said current performance results to update said historical performance data for subsequent optimizations.

12. The method according to claim 11 wherein said analyzing comprises:
performing an offline optimization by analyzing said historical performance data before runtime; and
performing an online optimization during a live user session by analyzing session-specific context data.

13. The method according to claim 11, wherein generating execution code for said optimized hook code bundle is performed using a large language model (LLM).

14. The method according to claim 13, wherein said generating execution code further comprises generating a prompt for said LLM based on said one or more optimization instructions.

15. The method according to claim 11, wherein creating said hook code bundle comprises merging logic from a plurality of hook codes into a single monolithic block.

16. The method according to claim 11, wherein creating said hook code bundle further comprises reordering an execution flow of a plurality of hook codes within said hook code bundle based on said historical performance data and stored WBS website data and stored WBS user data.

17. The method according to claim 11, wherein said logging saves said current performance results in said website session repository.

18. The method according to claim 11, wherein said historical performance data comprises at least one of: execution performance metrics, user environment data, and execution flow data.

19. The method according to claim 12, wherein said performing an offline optimization and said performing an online optimization comprises using at least one statistical algorithm from a group comprising statistical performance profiling, data mining, frequent itemset mining, and sequential pattern mining.

20. The method according to claim 11, further comprising selecting an optimization method from a group comprising at least a statistical model and a machine learning (ML) model, wherein said selection is based on available resources and execution context.
